(19) United States
(12) Patent Application Publication
(10) Pub. No.: US 2005/0240958 A1
(43) Pub. Date: Oct. 27, 2005

(54) Method and apparatus for on-demand multimedia rental and sales services

(75) Inventors: Tan D. Nguyen, Palo Alto, CA (US); Mark L.D. Chappell, Los Altos, CA (US); John Thomas, Mountain View, CA (US)

Correspondence Address: PILLSBURY WINTHROP SHAW PITTMAN LLP, P.O. BOX 10500, MCLEAN, VA, 22102, US

(73) Assignee: Moviecrazy, Inc., Palo Alto, CA (US)

(21) Appl. No.: 10/949,542

(22) Filed: Sep. 23, 2004

Related U.S. Application Data
(60) Provisional application No. 60/521,413, filed on Apr. 21, 2004.

(51) Int. Cl. H04N 7/16; H04N 7/173; H04N 7/167

(52) U.S. Cl. 725/20; 725/19; 348/461; 348/473; 348/468; 725/31

(57) ABSTRACT

The present invention provides a system and method for dispensing multimedia content. The invention discloses a network kiosk configured to receive multimedia materials from a variety of sources that may be stored, combined and recorded on mass storage devices such as solid state memory, multimedia players and rewriteable optical storage devices including rewriteable Digital Versatile Discs (DVDs) and rewriteable Compact Discs (CDs). Users may select material for purchase or rent at the kiosk or through external wired and wireless computing devices such as computers, cellular telephones, personal data assistants (PDAs), multimedia players.

### BACKGROUND OF THE INVENTION

1. Field of the Invention

The present invention relates to the distribution of multimedia data and more particularly to vending machines adapted to provide multimedia recordings on demand of generally.

2. Description of Related Art

Conventional multimedia product rental and sales methods require that products be available at a retail establishment or, in the case of mail order, be delivered within a matter days. Further, products that are not in inventory must be ordered and delivered, thereby incurring additional delays. Customers are often faced with the option of delay or choosing an alternative title.

Retail outlets offer the additional problem that opening hours are necessarily limited by local regulations and the prohibitive cost of operating and staffing the retail outlet during off-peak hours. Inventory management constraints also limit the ability of a customer to rent a title from one outlet and return the title to another outlet even where the outlets are commonly controlled and operated.

Additionally, conventional outlets do not cope well with unanticipated changes in demand for particular materials. Profitability depends to an extent on the ability of outlet management to predict demand for materials and to build an appropriate inventory. Thus, under-stocking a popular title can result in lost profits through lost business while overstocking may hinder the recouping of costs when rental levels of an unpopular title fail to meet expectations.

Thus, what is needed is a system that provides rapid access to multimedia materials on short notice. There is a need for retail outlets to maintain reduced inventory levels that nevertheless permit the outlet to satisfy all customer requests in timeframes measured in minutes rather than days. There is a need to provide customers with flexibility and increased availability to multimedia materials.

### BRIEF SUMMARY OF THE INVENTION

The present invention provides a system and method for dispensing multimedia content. The invention discloses a network kiosk configured to receive multimedia materials from a variety of sources that may be stored, combined and recorded on mass storage devices such as solid state memory, multimedia players and rewriteable optical storage devices including rewriteable Digital Versatile Discs (DVDs) and rewriteable Compact Disks (CDs). Users may select material for purchase or rent at the kiosk or through external wired and wireless computing devices such as computers, cellular telephones, personal data assistants (PDAs), multimedia players.

The kiosk operates with an administrative server to identify users of the system and to authorize distribution to the user of selected multimedia material. The kiosk may also provide targeted advertisements and marketing material to the user based on the user's prior purchases, rentals and stated preferences.

A remote administrator may initiate an audiovisual videoconference with the user to validate identification and resolve problems or answer questions. The user may obtain DVDs, CDs, preloaded multimedia players from the kiosk. The user may also receive materials by wired or wireless transfer from the kiosk. Further, the user may physically connect a storage device or a multimedia player to the kiosk to receive selected materials.

The kiosk combines material selected by the user, advertisements and marketing information, formatting information to create an image for the user. The kiosk may then create a final image by embedding a unique identifier and a pseudo-randomly spaced, encrypted signature into the image that permits identification of the source of the image. This feature, disclosed herein as a “watermark” permits identification of the source of pirated multimedia materials. In the case of a DVD, the image can be recorded onto a DVD.

The disclosed invention also utilizes a DVD programmer as disclosed in the related patent application No. 60/521,413 titled “Method and Apparatus with Multiple Read and/or Write Heads for Transferring Data in Parallel to And From Optical Recording Media,” incorporated herein by reference. Embodiments of the present invention include a DVD writer that uses a plurality of laser devices arranged in one or more head assemblies, wherein each of the one or more head assemblies operates independently to write an associated number of tracks simultaneously on one or more layers of the DVD. In these embodiments operation of the one or more head assemblies is typically coordinated to enable rapid DVD creation thereby reducing user wait times.

The disclosed invention thus provides on-demand access to a variety of multimedia materials that can be accessed without human intervention and provided in various embodiments according to the user's needs.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating an exemplary embodiment of the invention;

FIG. 2a is a block representation of various aspects of the kiosk according to the disclosed invention;

FIG. 2b is a diagram showing a communications controller according to aspects of the invention;

FIG. 2c is a block representation of the function of a media handler as disclosed by the invention;

FIG. 2d is a drawing illustrating DVD creation as disclosed in aspects of the invention

FIG. 3a is a flow diagram illustrating the method by which a DVD is dispensed by a kiosk in an exemplary embodiment of the invention;

FIG. 3b is a flow diagram illustrating a method for creating a unique identifier and watermark according to aspects of the invention; and

FIG. 4 is a flowchart illustrating the process by which a DVD may be returned to the kiosk in an exemplary embodiment of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention. Where certain elements of these embodiments can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

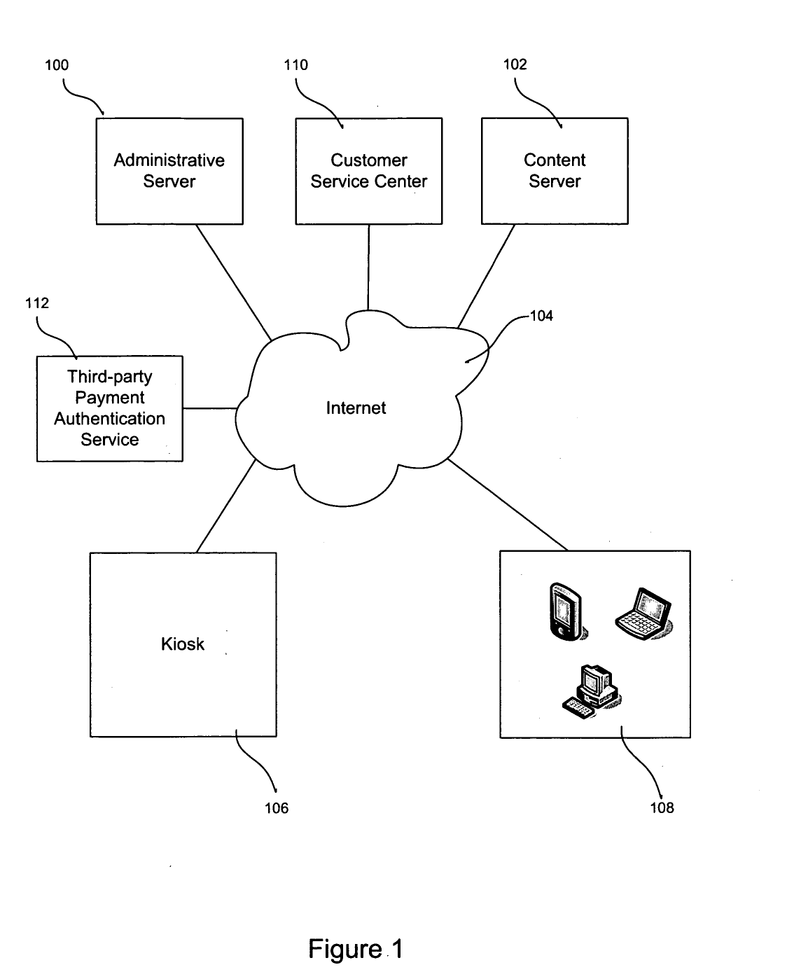

Referring to FIG. 1, embodiments of the invention comprise an administrative server 100, a content server 102, a kiosk 106, typically connected by a network 104 such as the Internet. The kiosk 106 provides users with access to the disclosed system for multimedia rental and sales. In various embodiments, the user provides identification that is validated electronically or manually using the facilities of the kiosk 106. In these embodiments, the user typically provides identifying information such as a username, a password or some other unique identifying code. The kiosk 106 is adapted to receive identifying data through a plurality of means including touch screen, keyboard, card reader, external wired and wireless computing devices such as computers, cellular telephones, personal data assistants (PDA), multimedia players. It will be appreciated that, in some embodiments, a single device may serve multiple functions; for example, a kiosk 106 could serve as a content server 102 for another kiosk and, likewise, a content server 102 and administrative server 100 could reside on a single physical device.

The kiosk 106 is further adapted to provide video images of the user and any proffered identifying material such that an administrator may remotely confirm identity by visual inspection of the user and remotely examine the proffered materials. In many embodiments, the administrator is located at a customer service center 110. In other embodiments, the administrator may be collocated with the kiosk 106, but the administrator may be located in any place that access to the network 104 is available. The administrator typically has access to information contained on the administrative server 100 and may initiate data transfers between the content server 102 and the kiosk 106. In at least some embodiments, the kiosk 106 includes audiovisual equipment to support bidirectional audio and video communications to facilitate identification of the user and the provision of assistance to the user by the administrator.

Having validated the user identity, the kiosk 106 operates in conjunction with the administrative server 100 and the administrator to confirm that the user is authorized to receive selected multimedia materials from the kiosk 106. Authorization is granted based on indicia including age of the user, status of user account, location of the user and laws, rules and regulations governing the sale or lease of multimedia materials at the location of the kiosk 106.

The kiosk 106 is further adapted to enable the user to select multimedia materials for rental and purchase and permits selection of the format and quantity in which the materials will be delivered. In some embodiments, the user may select portions of multimedia materials from a plurality of sources and may arrange the materials in any preferred sequence. The kiosk 106 is adapted to receive multimedia materials from a plurality of content servers 102, to store the materials and to create copies of the materials in a form that the user may physically remove from the kiosk 106. Suitable forms include, for example, rewriteable DVDs, rewriteable CDs and other writeable mass storage devices. It will be appreciated that other write once, read many (WORM) media Where the user has previously rented multimedia materials, the kiosk is configured to receive a return of the materials, to identify the renting user and update account information on the administrative server 100 accordingly.

A user may also use remote communications or computing devices 108 to order multimedia materials for pickup or delivery at a selected kiosk 106. The remote devices 108 include computers, personal data assistants (PDAs), cellular phones, multimedia players and other such equipment. Further, users may contact a customer service center 110 to facilitate ordering of multimedia materials for delivery or pickup, typically at a kiosk 106.

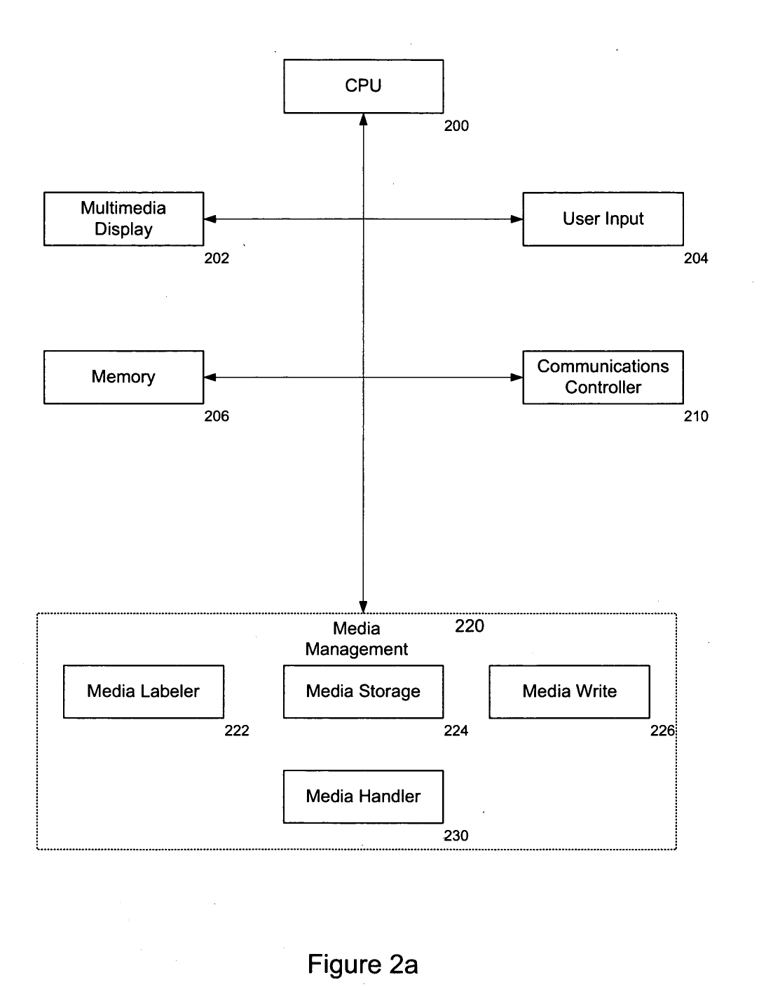

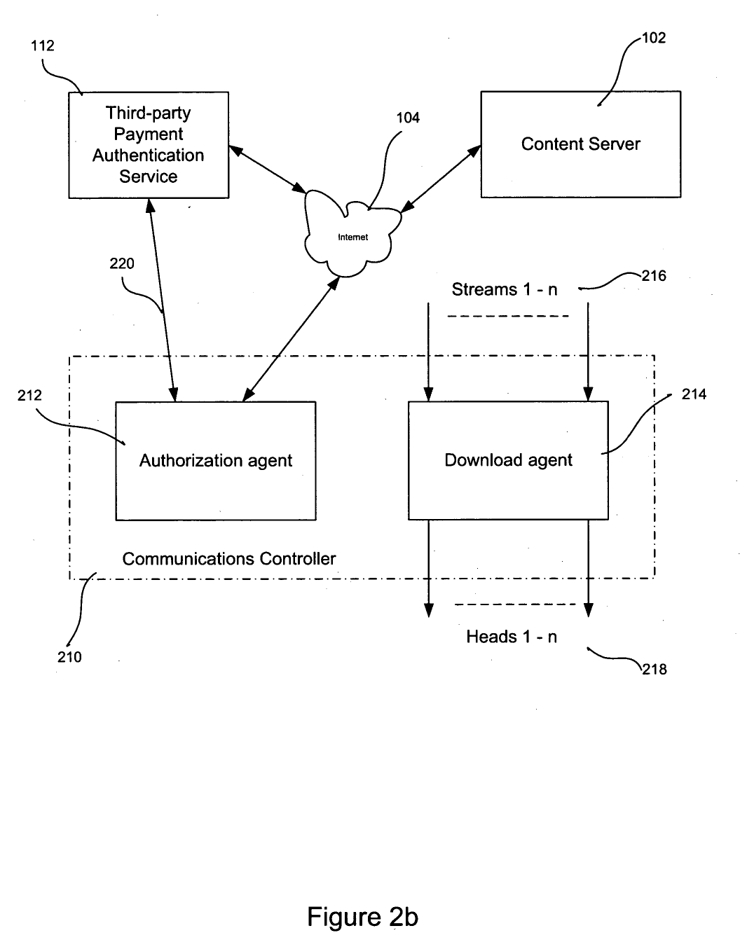

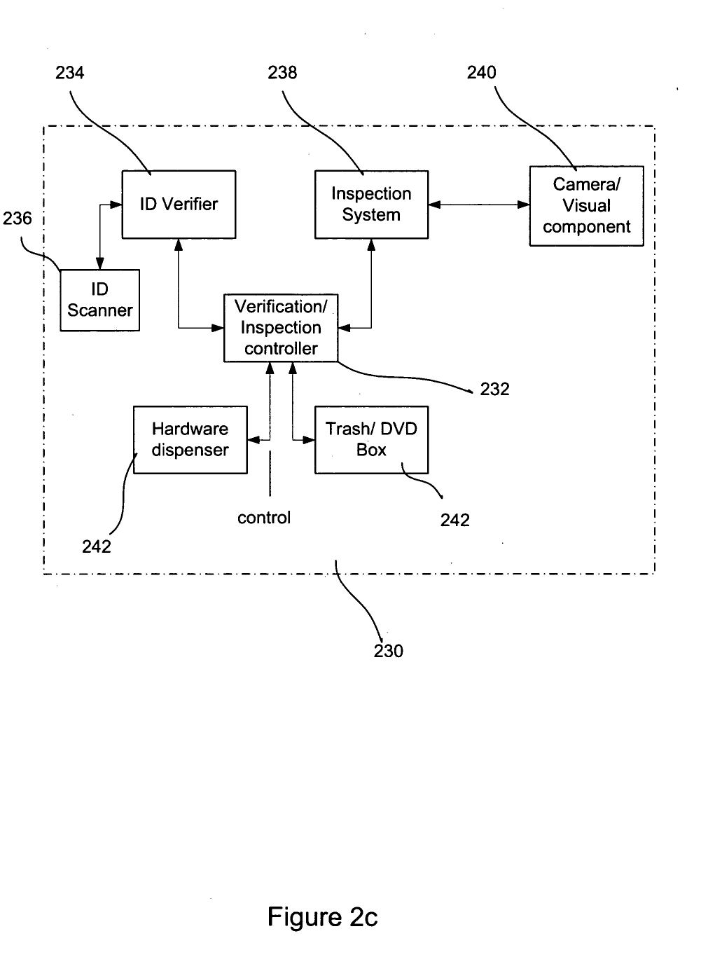

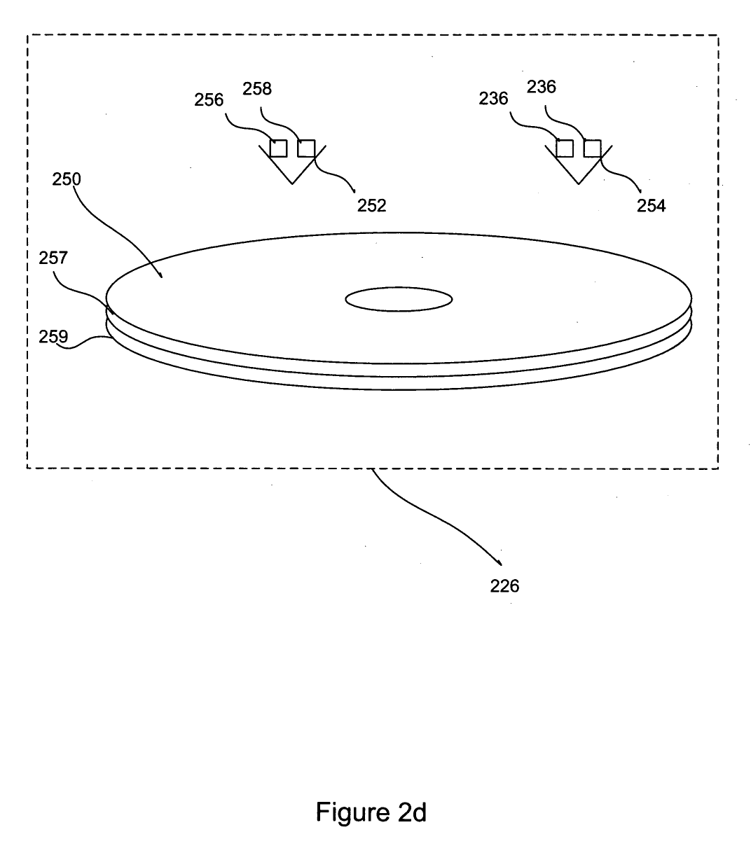

The block diagram of FIG. 2a, viewed together with FIG. 1, illustrates an exemplary embodiment of the kiosk 106. A CPU 200 for controlling systems activities is connected to one or more multimedia display systems 202, one or more user input devices 204, a memory system 206, one or more communications controllers 210 and a media management system 220. In some embodiments, the CPU 200 is a commercial computing system such as a PC, a single-board computer, a microcontroller or other suitable computing device.

The one or more display systems 202 and the one or more input devices 204 permit users to interact with the system to obtain copies of multimedia materials. In some embodiments, users may choose a delivery method for the multimedia materials where the available methods include prerecorded storage media such as DVDs, data streams to be captured at a kiosk 106 by the multimedia players in the user's possession and preloaded multimedia players. In some embodiments, data streams may be captured using wireless communications and by physically docking or otherwise connecting a multimedia player or storage device to the kiosk 106.

Embodiments of the invention use a combination of display systems 202 including CRT displays, LCD displays, data display panels, multimedia projectors, Braille-enabled systems and any suitable graphic or data display system. The kiosk 106 use the display systems to present a variety of information to the user including data, live video, multimedia previews, advertising and marketing information and troubleshooting information. Administrators may use the display systems 202 to initiate a videoconference with the user.

In various embodiments of the invention, the input devices 204 include keyboards, keypads, touch-screens, pointers (such as a mouse), audiovisual equipment, wireless communications receivers and other suitable input devices. In these embodiments the audiovisual equipment has bidirectional capability and includes include microphone and loudspeakers for audio communication, video cameras and document scanners. In at least some of these embodiments, the user can use input devices to initiate a video conference with an administrator. In many embodiments, the input devices 204 also include biometric readers and scanners such as fingerprint readers, iris scanners and optical face recognition systems.

The memory system 206 provides a means for receiving and storing multimedia image. In various embodiments, the multimedia images include movie titles, video and computer gaming software, audio recordings, recordings of television and radio programming video material and marketing and advertising materials. The memory system 206 comprises disk drives and fast volatile and non-volatile memory devices typically used to cache frequently used data. In at least some embodiments, data stored in the memory system 206 is encrypted, crippled or otherwise protected to prevent misappropriation by physical or electronic removal of the contents the memory system 206. Data may be crippled by erasing selected portions of the data, preferably such that the erased portions include information necessary to unlock, decrypt, navigate, order or otherwise access the remaining data. In these embodiments, data is retrieved from the memory system 206 upon obtaining authorization from the administrative server 200 by, for example, decrypting the data, providing decryption keys and restoring erased data. The restoration of erased data typically involves requesting copies of the encryption keys and destroyed data portions from the content server 102 or from one or more content providers.

Referring now to FIGS. 1, 2a and 2b, the one or more communications controllers 210 are connected to networks that facilitate communication with a plurality of devices and systems including, for example, content servers 102, content providers, other multimedia providers, one or more administrative servers 100, other kiosks 106 and a plurality of users equipped with remote communications or computing devices 108.

In some embodiments, the one or more communications controllers 210 manage a plurality of connections. For example, an authorization agent 212 may be included in the communications controller 210 to authorize financial transactions (e.g. credit cards) with a third-party payment authorization service 112 using a dedicated secure communications connection 220.

In many embodiments, a plurality of data streams 216 provide faster access to multimedia materials located on remote content servers 102. In these embodiments, each of the plurality of data streams 216 is typically carried independently of the other data streams on separate communication links. The plurality of data streams may recombined and routed to the memory system 206 but, in at least some embodiments, the plurality of data streams may be routed directly to the media management system for direct recording to, for example, DVD.

To obtain multimedia materials, the communications controller 208 establishes connections with content providers such as one or more content servers 102. Where necessary, the communications controller 210 negotiates with the content providers to configure distinct data streams such that the distinct streams may be recombined or utilized upon receipt. Additionally, the communications controller initiates secure connections with third-party authorization services 112. The communications controller 208 also manages connections with other system components including kiosks 106, administrative servers 100 and content servers 102.

Referring now to FIGS. 1, 2a and 2c, the function of the media management system 230 may be understood using exemplary embodiments that provide multimedia materials recorded on DVDs. In these embodiments a media management system 220 includes media storage 224 for storing blank or rewriteable media (such as DVDs, CDs and non-volatile memory devices), media writers 226 for receiving multimedia data images from the memory system 206 or directly from the communications controller 210 and writing the data images on the blank or rewriteable media and a media labeler 222 for imprinting or attaching a label to the media. The media management system 220 further includes a media handler 230 that receives and processes DVDs returned by the user.

In the exemplary embodiment, data images are typically recorded on DVDs. The data images typically comprise one or more video titles (such as featured movies), targeted advertising and other marketing material. Advertising is targeted using information provided by the administrative server 100 and associated with the user based on information such as prior rentals and purchases, location of rental and other demographic information maintained by the administrative server 100.

In the exemplary embodiment, the media labeler 222 receives from the CPU 200, information related to data recorded on the disk, the user and the system providing the DVD. The media labeler 222 attaches the information on the DVD using methods appropriate to the type of DVD used and intended use of the DVD. The methods of attaching information include attaching a printed label, permanent imprinting of the DVD surface and temporary imprinting of the DVD where the DVD is coated with rewritable dyes such as leuco dyes. The information may include copyright notices, title information, return date and return mailing address.

Referring now to FIGS. 1, 2a and 2d, in at least some embodiments, the media writer 226 comprises a DVD writer as disclosed in the related patent application No. 60/521,413 titled “Method and Apparatus with Multiple Read and/or Write Heads for Transferring Data in Parallel to And From Optical Recording Media.” The DVD writer disclosed in the latter application is capable of receiving a plurality of data streams that can be directed to a plurality of recording head assemblies 252 and 254 per recording layer 257 and 259, thereby enabling rapid DVD creation. The use of the plurality of recording head assemblies enables write time reductions that may be orders of magnitude faster than a DVD writer equipped with a single write head assembly.

For the purpose of this discussion only, the exemplary embodiment as shown in FIG. 2d supports two recording head assemblies 252 and 254 and it will be assumed that one or more data streams are received from the communications controller 210 (as described above) or one or more data streams are received from the memory system 206. It will be understood by one skilled in the art, that the each of the two recording head assemblies 252 and 254 contains one or more laser writers 256 and 258 for writing different layers of the DVD 257 and 259. For example, one of the two laser writers 256 may write an upper layer 257 of the DVD 250 while the other of the two laser writers 258 writes a lower layer 259 of the DVD 250. Because the heads 252 and 254 are located at different distances 253 and 255 from the center of the DVD 250, the process of recording the DVD 250 is speeded significantly. It will be appreciated that in various embodiments, more than two heads may be used and more than two layers in the DVD can be written.

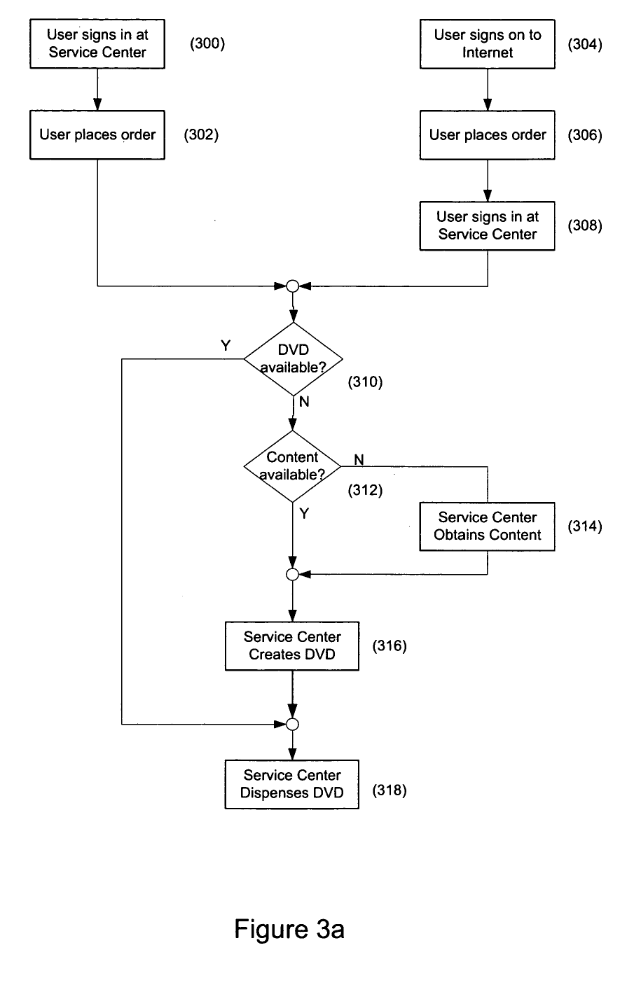

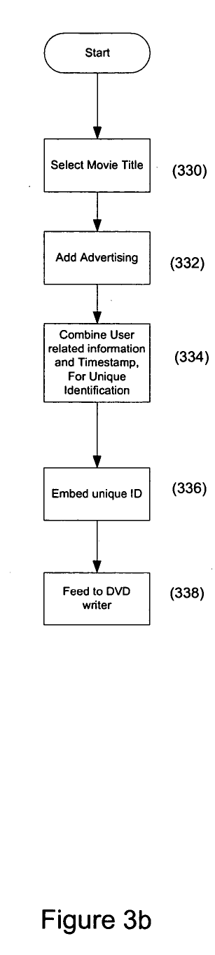

Referring now to FIG. 3a, the process used to provide multimedia materials for rent or purchase may be understood. In many embodiments, users obtain the multimedia materials prerecorded on physical media or download the multimedia materials from a kiosk 106. In an exemplary embodiment of the invention, users initiate the process of obtaining a DVD by providing identification 300 and 304 to the administrative server 100 and subsequently selecting the content of the DVD. As shown in the flowchart of FIG. 3a, the user may be physically present at the kiosk 106 to provide identification 300 or the user may use any appropriate networked wired or wireless electronic device 108 to provide identification 304. Identification may be provided 300 and 304 by means including entering unique codes and passwords, providing a credit card or other means of payment, providing account information, visual identification and providing biometric information.

After providing valid identification, the user may select content to be provided on the DVD 302 and 306. In selecting the content, the user may combine portions of materials provided from multiple sources. The kiosk 106 confirms the user selection and requests authorization from the administrative server 100 before releasing the content for creation of a DVD. The administrative server 100 authorizes the release of the content based on factors including licensing requirements, applicable law and demographic information gathered from the user such as age, location of residence and location of rental jurisdiction).

Having obtained authorization from the administrative server 100, the kiosk 106 assembles additional information to be recorded on the DVD. The additional information includes advertising and marketing material that may be targeted to the user based, in part, on demographic information obtained from the user, past purchases or rentals of the user and other such factors. In at least some embodiments, the kiosk also creates a unique identifier for the DVD identifying content, user and date and location of rental. The identifier is recorded in a database on the administrative server and is used to, for example, convert a rental to a purchase if the user does not return the DVD within a selected time; conversion entails notifying the user and subsequently charging the user for the difference between rental and purchase price. The unique identifier can also be used to assist in identifying copyright violations involving the licensed content.

Referring also to FIG. 3b, the unique identifier may be used to encode the content of the recorded DVD with a concealed pattern hereinafter referred to as a watermark. In some embodiments the watermark is applied to portions of the DVD content, including, for example, unused tables, unused indexes and unused subtitle storage. In at least some embodiments, the watermark is applied to the multimedia materials selected by the user. In some embodiments watermark is typically concealed by writing randomly coded data at randomly calculated locations within the DVD. Randomness is typically achieved using algorithms that are well-known in the art or using proprietary techniques.

The flowchart of FIG. 3b illustrates the creation of the unique identifier and watermark. The user selects one or more movie titles, multimedia materials and other content 330. The kiosk 106 creates an initial image by combining DVD management information with, for example, marketing and advertising materials 302, where the advertising material is selected according to factors including a history of past rentals and purchases of the user, previously supplied preferences of the user, location of the kiosk 106, date of rental or purchase, demographic information provided by the administrative server 100 and other factors determined by an administrator.

In exemplary embodiments, after generating the initial image, a unique identifier is typically created 304 by combining information including a combination of user-related identifiers such as account numbers, timestamp information identifying date and time of creation of the initial image, biometric identifiers, telephone numbers, passwords, credit card numbers, and so on. The unique identifier is provided to the administrative server 100 where it is stored and cross-referenced to the user's account and contact information. In some embodiments, the unique identifier is created by combining the above-described identifying information to form one or more encryption keys which may be used to create the watermark.

Continuing with the latter exemplary embodiment, the unique identifier enables an algorithm to create an apparently random sequence of write locations within the DVD and a watermark. In some embodiments, a final image is generated by embedding the watermark in the initial image 306 at locations designated by the created sequence of write locations. Other embodiments may create the final image by writing the watermark into predetermined data blocks. The final image is then fed to the DVD writer 308 for creation of a DVD. Because the watermark is typically written into unused blocks of data on the DVD, the watermark does not affect the operation of the DVD. Without access to the unique identifiers, detection of the watermark is extremely difficult. When the watermark is available, the write locations and the form of the watermark are known and can be easily detected. Therefore, a watermark on a DVD may be used to trace the user who obtained the original content of the DVD and details of the associated transaction.

Returning to the flowchart of FIG. 3a, in generating the initial image, the kiosk 106 checks its media management system 220 for availability of a previously recorded DVD containing the selected content 310. If a previously recorded DVD exists, the kiosk 106 writes new watermarks over the existing data. If no DVD is immediately available, then the kiosk 106 checks its memory system 206 for presence the content 310. If the content is present the kiosk initiates creation of a DVD 316. If the content does not reside in the memory system, the kiosk 106 obtains the content 314 from a content server 102 before proceeding with DVD creation 316. In some embodiments, only partial images of copyrighted materials are maintained in the kiosk and the remaining data must be obtained by download from a content server 102 under authorization obtained from the administrative server 100.

Having identified all content, the kiosk 106 notifies the user of estimated time to provide a DVD. If the user has placed an order remotely, the user may then travel to the kiosk 106 and provide identifying information related to the order 308.

When the DVD has been created 316, in some embodiments the DVD is labeled by direct imprint or application of a label (as discussed previously). The DVD is then packaged for delivery to the user. Finally, the kiosk 106 dispenses the DVD to the user 318 by passing the DVD to the user through a tray, slot, slit or other suitable mechanism.

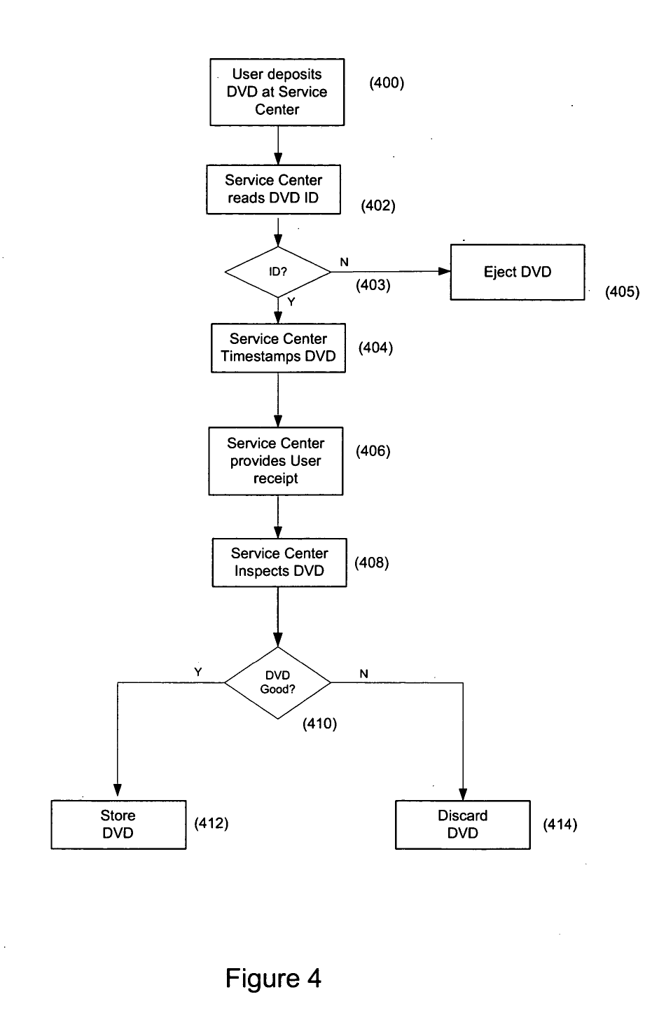

Referring now to FIG. 4 together with FIGS. 1, 2a and 2c, the return process in an exemplary embodiment may be understood. The return process begins 400 when the user deposits the DVD in the kiosk 106. The kiosk includes a media handler 230 that is controlled by a verification/inspection controller 232. It will be appreciated that the verification/inspection controller may be a single board computer a programmable logic device, and ASIC or other programmable controller. The user deposits a DVD into a return device or a dual-purpose hardware dispenser 242 that may be in the form of a tray, bin, slot, slit or other suitable mechanism. For example, the DVD may be inserted into a slit such that the DVD engages one or more motorized rollers that pull the DVD into a mechanism that manipulates the DVD, removing any envelope or other cover and orients the DVD for further processing. It will be appreciated that in some embodiments, the DVD may be removed from any covering by mechanical means and may be handled using techniques commonly used in jukeboxes and other such equipment.

The DVD is then scanned by an ID Scanner 236 for identifying information 402 attached to the DVD during purchase or rental. The identifying information may be contained on a label or the surface of the DVD and may be encoded in the recorded content or on a DVD enclosure. If no identifier is detected 403, the DVD may be rejected 405 and returned to the user. One or more scanners may be controlled by an ID verifier 234. Thus embodiments of the invention obtain the DVD identification by reading barcodes, character recognition or other suitable technology. Other embodiments may read the identifying information from the recorded content.

In the exemplary embodiment, the kiosk 106 typically imprints the DVD with a timestamp 404 recording date and time of receipt and may provide a receipt for the user 406. The kiosk 106 typically transmits the DVD ID and timestamp information to the administrative server 100 for validation and to update the user's account information. The administrative server 100 may subsequently update account information, catalog the received DVD and update management information.

Having identified the DVD, a verification/inspection controller 232 in the exemplary embodiment initiates an inspection of the DVD for flaws including scratches, foreign objects, congealed liquids and other damage. In some embodiments inspection may comprise a combination of visual inspection 240 and test reading of the recorded content. Inspection may be performed by a combination of a plurality of means including optical, infrared, ultrasonic, laser, ultraviolet technologies. History of usage of the DVD may be used to determine if the DVD has exceeded its useful lifetime. If the DVD passes inspection 410, then it is stored for further use 412 in the media storage device 224; otherwise the DVD may be marked as damaged and discarded 414 into a trash container 242. Prior to storing the DVD in the media storage device 224, the content of the DVD may be rendered unreadable by removing encryption keys, obliterating portions of the content or using some other method.

It is apparent that the above embodiments may be altered in many ways without departing from the scope of the invention. For example, Further, the invention may be expressed in various aspects of a particular embodiment without regard to other aspects of the same embodiment. Still further, various aspects of different embodiments can be combined together. Accordingly, the scope of the invention should be determined by the following claims and their legal equivalents.

1. A system for delivering multimedia data to a user, the system comprising:
means for combining the multimedia data with a unique identifier, which is traceable to the user, in order to produce tagged multimedia data;
means for transferring the tagged multimedia data to a memory device, wherein the memory device can be delivered to the user.

2. The system of claim 1 wherein the means for combining comprises:
means for retrieving the multimedia data from a data bank;
means for generating the unique identifier;
means for embedding the unique identifier at various location throughout the multimedia data, wherein the embedding process is randomly generated in accordance with a random generating algorithm.

3. The system of claim 1 wherein the means for transferring comprises:
means for partitioning the tagged multimedia into a plurality of blocks;
means for simultaneously transferring the plurality of block via a plurality of paths to the memory device.

4. The system of claim 3 wherein the memory device is an optical memory device with rewrite capability.

5. The system of claim 2 further comprising a polymer-based label affixed to one surface of the optical memory device.

6. A system comprising:
a service center for delivering unique multimedia to a user;
a central service center coupled to the kiosk for management of user information relating to the user and multimedia data that is used to create the unique multimedia; and
a content server coupled to the kiosk for providing the multimedia data.

7. The system of claim 6 wherein the service center comprises:
a central processing unit in communication with the central customer service center for managing the communication and delivery of the multimedia data;
a media management unit coupled to the central processing unit for generating the unique multimedia; and
a communications controller coupled to CPU for managing the communication between the service center and the central customer service center and the content server.

8. The system of claim 7 wherein the media management unit comprises:
an encryption of the multimedia data with tags unique to the user for generating the unique multimedia data;
means for partitioning the tagged multimedia into a plurality of blocks;
means for simultaneously transferring the plurality of blocks via a plurality of paths to a memory device.

9. The system of 8 wherein the memory device is an optical memory device and further comprising a media scanning device for scanning the optical memory device for defects.

10. A system for delivering tagged multimedia to a user, the system comprising:
a central processing unit;
a user interface coupled to the central processing unit;
a display coupled to the central processing unit; and
a media management unit coupled to the central processing unit for delivering the tagged multimedia to the user, wherein the tagged multimedia is a combination of multimedia data and encoded data and wherein the encoded data includes information that is unique to the user.

11. The system of claim 10 wherein the tagged multimedia is stored on an optical storage.

12. The system of claim 11 wherein the media management comprises:
a media labeling unit for applying a polymer label to the optical storage;
a media transfer unit for transferring the tagged multimedia onto the optical storage; and
a media storage unit for storing multimedia data.

13. The system of claim 12 wherein the transfer unit comprises:
means for splitting the tagged multimedia into a plurality of data blocks; and
means for simultaneously transferring at least two of the plurality of blocks to the optical storage, wherein the means for simultaneously transferring is coupled to the splitting means.

14. The system of claim 12 comprising an optical scanning unit coupled to the central processor for determining the condition of the optical storage.

15. A method for delivering storage medium containing tagged multimedia data to a customer, the method comprising the steps of
retrieving the multimedia data from a memory device;
randomly embedding the retrieved multimedia data with unique data to produce the tagged multimedia data, wherein the unique data includes information that is unique and traceable to the customer;
transferring the tagged multimedia data to the storage medium that is delivered to the customer.

16. The method of claim 15 further comprising the steps of:
verifying the customer as an authorized user;
storing the unique information about the customer for future verification and tracing.

17. the method of claim 15 wherein the step of transferring comprises the steps of:
splitting the tagged multimedia into a plurality of data blocks; and
transferring at least two of the plurality of blocks to the optical storage.

18. The method of claim 15 further comprising the steps of:
initiating a communication session with a financial institution to verify terms of payment;
customizing advertisement for transfer onto storage medium, wherein the advertisement is unique to the user;
labeling the storage medium with a polymer based label, wherein the label in re-writable.

19. The method of claim 17 comprising the step of transferring at least two a pairs of the plurality of blocks onto an bi-level optical storage medium, wherein each of the pairs of the plurality of blocks is transferred onto each level of the optical storage medium.

20. A method for renting a movie to a customer, the method comprising the steps of:
receiving at least one request from the customer for the movie that the customer desires to rent;
randomly embedding the movie with unique data to produce a tagged movie, wherein the unique data includes information that is unique and traceable to the customer;
transferring the tagged movie to a storage medium, wherein the storage medium is rented to the customer.

21. The method of claim 20 further comprising the steps of:
verifying the customer as an authorized user;
storing information about the customer for future verification and tracing.

22. The method of claim 20 wherein the step of transferring comprises the steps of:
splitting the tagged movie into a plurality of data blocks; and
transferring at least two of the plurality of blocks to the storage.

23. The method of claim 22 further comprising the steps of:
initiating a communication session with a financial institution to verify payment for the movie rental;
customizing advertisement for transfer onto the storage medium, wherein the advertisement is unique to the customer;
labeling the storage medium with a polymer based label, wherein the label in re-writable.

24. The method of claim 22 comprising the step of transferring at least two a pairs of the plurality of blocks onto a bi-level optical storage medium, wherein each of the pairs of the plurality of blocks is transferred onto each level of the optical storage medium.

25. A method for preparing targeted tagged data for delivery to a customer, the method comprising the steps of:
randomly embedding data with unique data to produce tagged data, wherein the tagged data includes information that is unique and traceable to the customer;
customizing the tagged data with targeted data to produce targeted tagged data, wherein the targeted data is selected based on advertisement data related to the customer's preferences.

26. The method of claim 25 wherein the tagged multimedia is stored on an optical storage.

27. The method of claim 26 further comprising the steps of:
applying a polymer label to the optical storage;
transferring the tagged data onto the optical storage; and
storing multimedia data.

28. The method of claim 27 further comprising:
splitting the tagged multimedia into a plurality of data blocks; and
simultaneously transferring at least two of the plurality of blocks to the optical storage.

29. The method of claim 27 comprising the step of transferring at least two a pairs of the plurality of blocks onto a multi-layer optical storage medium, wherein each of the pairs of the plurality of blocks is transferred onto each level of the optical storage medium.

30. The method of claim 29 comprising the step of verifying financial information for the customer.
